(19) United States
(12) Patent Application Publication
(10) Pub. No.: US 2026/0348567 A1
(43) Pub. Date: Nov. 5, 2026

(54) ILLUMINATION DEVICE

(71) Applicant: DAN LEASK, Milford, NJ (US)

(72) Inventor: DAN LEASK, Milford, NJ (US)

(21) Appl. No.: 19/450,761

(22) Filed: Jan. 16, 2026

Related U.S. Application Data
(60) Provisional application No. 63/746,284, filed on Jan. 17, 2025.

(51) Int. Cl. F21V 21/08; F21L 4/08

(52) U.S. Cl. CPC F21V 21/08; F21L 4/08

(57) ABSTRACT

The mouth held lighting device as described herein preferably comprises a lighting element and a mouthpiece. A cover may be used to help protect and keep the mouthpiece clean from debris. The mouth held lighting device allows a user to free up their hands to complete various tasks in a darkened environment that otherwise could not be accomplished.

### CROSS-REFERENCE TO RELATED APPLICATIONS

This application is a U.S. Non-Provisional Utility Patent Application which further claims priority to co-pending U.S. Provisional Patent Application No. 63/746,284, filed on Jan. 17, 2025, the contents of which are hereby fully incorporated by reference.

### FIELD OF THE EMBODIMENTS

The field of the embodiments of the present invention relates generally to lighting elements and in particular lighting elements that can be held by the mouth of a user of the lighting element.

### BACKGROUND OF THE EMBODIMENTS

The use of flashlights of diverse designs having a wide variety of supports and controls is known. However, conventional flashlights require the use of one or more hands to control and direct the light emanating from the flashlight. Further, physical tasks often require the use of both hands of a person requiring illumination of their environment. For example, mechanics, contractors, pest control, and similar workers, often need to use both their hands while performing their day-to-day jobs. Even further, insufficient environmental light often comes hand in hand with said job and requires an additional light source, such as a flashlight.

In order to both complete the job and receive the required amount of light, one would have to use one hand to hold the light source and perform the job solely with the other hand or find a place to position or balance the light source in order to attempt to free up the other hand. In doing so, the light source can fall, not illuminate the appropriate area, or may cause damage or injury. Occasionally, one may even attempt to hold the light source in their mouth. This may further cause injury or discomfort and inhibit the ability of the individual to interact with others on the job site. Accordingly, there is a need for a hands-free operable illuminating device for providing additional light to users, in an easy and reliable manner.

Review of related technology:
U.S. Pat. No. 5,063,483 pertains to a battery powered light with a mouthpiece that includes the combination of an illuminating means and a mouthpiece. In use, a user can hold the illuminating means by gripping the mouthpiece and directing the light source in a particular manner. The combination of an illuminating means and a mouthpiece permits the illuminating means to be used while the hands of a user are free to perform specific tasks.
U.S. Pat. No. 5,485,357 pertains to a flashlight with mouth support and associated controls with a flashlight having a forward end with a bulb, a rearward end with a separable cap with a spherical recess, and an intermediate cylindrical extent therebetween; a mouthpiece fabricated of an elastomeric material with an arcuate inner surface adapted to be supported by the teeth of a user and an enlarged external surface positionable between the teeth and lips of the user and a central post extending forwardly thereof; and electrical coupling components between the mouthpiece and the flashlight including a central axial aperture extending from the flashlight to the cap and an intermediate section of the mouthpiece with electrical wires extending therethrough.
U.S. Pat. No. 7,972,024 pertains to an illuminating device that includes a light source and a mouthpiece. The mouthpiece is configured to adapt the light source thereon and is capable of being accommodated within a user's mouth. The mouthpiece includes a switch and a power source. The switch is electrically connected to the light source. The power source is electrically connected to the switch and the light source and is capable of providing electrical power to the light source for illumination. Upon receipt of the mouthpiece within the user's mouth and application of pressure on the switch by the user's teeth, the light source is illuminated.
U.S. Pat. No. 12,064,307 pertains to a whitening light that includes a mouthpiece having a light array arranged along the mouthpiece for directing light onto an exposed portion of the teeth of a user. The whitening light includes a rear portion comprising a first power source communicably coupled to the light array and a first charging mechanism configured to receive power transferred from a second charging mechanism located on a case for the whitening light. The first power source includes a rechargeable battery charged by the second charging mechanism to a power output sufficient to power the whitening light to emit light configured to whiten teeth upon selection of a button on the rear portion of the whitening light to commence a treatment session, to emit the light for a predetermined duration corresponding to a duration of the treatment session, and to automatically switch the light array to an off-setting following expiration of the predetermined duration.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### BRIEF SUMMARY OF THE EMBODIMENTS

In general, the mouth held lighting apparatus of the present application is directed to a lighting device that comprises one or more lighting elements thereon. The one or more lighting elements may be operated (color, intensity, flashing pattern, etc.) by a depressible switch. A charging port allows for convenient charging of one or more lighting elements when said power source coupled to said lighting elements is rechargeable. Further, a mouthpiece is coupled to the housing having one or more lighting elements, charge port, depressible button, etc. In some embodiments, the mouthpiece may be removable from the housing to allow for easier storage, cleaning, and the like. The mouthpiece may be retained on the housing by one or more retaining elements. A cover for the mouthpiece, which may be used when the mouthpiece is coupled to the housing, prevents debris and other materials from soiling the mouthpiece.

In one aspect of the present invention there is a mouth held lighting apparatus that has a lighted housing having a first end and a second end, where the second end of the lighted housing has a protrusion, at least one lighting element coupled to the first end of the lighted housing, a depressible button configured to change an operable state of the at least one lighting element, a mouth piece having a first end and a second end, where the first end of the mouthpiece has a recess and a second end of the mouthpiece is configured to be inserted into a mouth of a user.

The mouth held lighting apparatus may further includes a lens configured to cover the one or more lighting elements.

The mouth held lighting apparatus may also include a cover.

The mouth held lighting apparatus may also include one or more status indicators.

The mouth held lighting apparatus may also include a charging port.

The mouth held lighting apparatus may also include where the second end of the mouthpiece is arcuate in shape and has a first bite pad and a second bite pad.

The mouth held lighting apparatus may also include where the mouthpiece is coupled to the housing via a retention rib.

In another aspect of the present invention there is a mouth held lighting apparatus includes: a lighted housing having a first end and a second end, where the second end of the lighted housing has a protrusion and at least one retainment mechanism coupled to the protrusion, at least one lighting element coupled to the first end of the lighted housing, a depressible button configured to change an operable state of the at least one lighting element, a mouth piece having a first end and a second end, where the first end of the mouthpiece has a recess and a second end of the mouthpiece has a first bite pad and a second bite pad, where the recess has at least one groove configured to receive the at least one retainment mechanism coupled to the protrusion of the lighted housing.

The mouth held lighting apparatus may also include where the first bite pad is not affixed to the second bite pad.

The mouth held lighting apparatus may also include a universal serial bus charging port disposed in the lighted housing.

The mouth held lighting apparatus may also include a cover configured to selectively cover the mouthpiece.

The mouth held lighting apparatus may also include a light pipe configured to direct light to one or more status indicators.

The mouth held lighting apparatus may also have a cover configured to couple to the lighted housing via one or more securement mechanisms.

In yet another aspect of the present invention there is a mouth held lighting apparatus that includes a lighted housing having a first end and a second end, where the second end of the lighted housing has a protrusion and at least one retainment mechanism coupled to the protrusion, at least one lighting element coupled to the first end of the lighted housing, a lens configured to cover the at least one lighting element, a power source configured to supply electrical power to the at least one lighting element, a charging port operably coupled to the power source, a depressible button configured to change an operable state of the at least one lighting element, a mouth piece having a first end and a second end, where the first end of the mouthpiece has a recess and a second end of the mouthpiece has a first bite pad and a second bite pad, where the recess has at least one groove configured to receive the at least one retainment mechanism coupled to the protrusion of the lighted housing, and a covering having a first section and a second section with the first section and the second section defining an interior volume.

The mouth held lighting apparatus may also include where the cover is configured to cover the mouthpiece.

The mouth held lighting apparatus may also include where an interior volume formed by the cover is larger than the mouthpiece.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a first perspective view of an embodiment of the present invention.

FIG. 2 illustrates a second perspective view of an embodiment of the present invention.

FIG. 3 illustrates a top view of an embodiment of the present invention.

FIG. 4 illustrates a side view of an embodiment of the present invention.

FIG. 5 illustrates a front view of an embodiment of the present invention.

FIG. 6 illustrates another perspective view of an embodiment of the present invention with a covering for a mouthpiece removed.

FIG. 7 illustrates a top view of an embodiment of the present invention with a covering for a mouthpiece removed.

FIG. 8 illustrates a top view of an embodiment of the present invention with a mouthpiece removed from the lighting element.

FIG. 9A illustrates a first perspective view of an embodiment of the present invention with a mouthpiece removed from the lighting element.

FIG. 9B illustrates a second perspective view of an embodiment of the present invention with a mouthpiece removed from the lighting element.

FIG. 10 illustrates an exploded view of an embodiment of the present invention.

FIG. 11 illustrates a sectional side view of an embodiment of the present invention taken along Line 11 in FIG. 3.

FIG. 12 illustrates a preferred method of use of an embodiment of the present invention.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

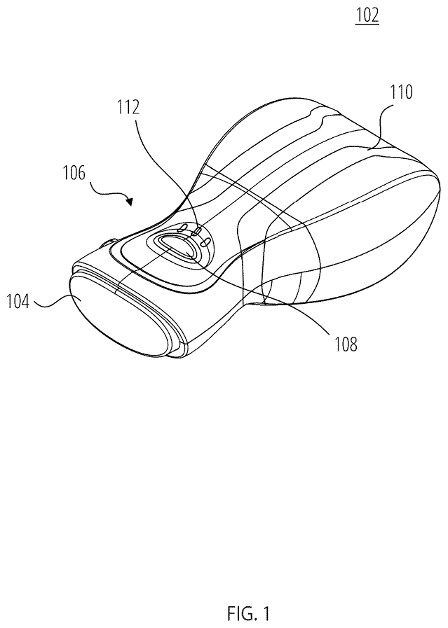

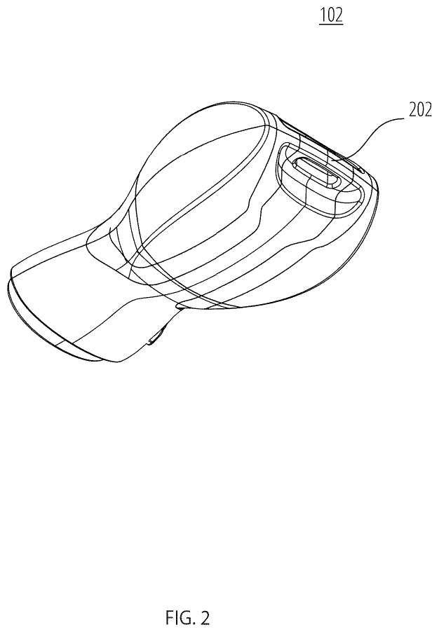

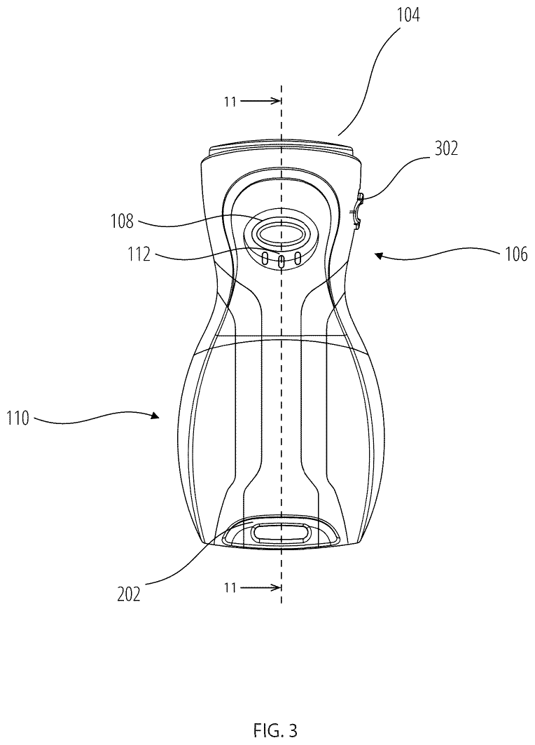

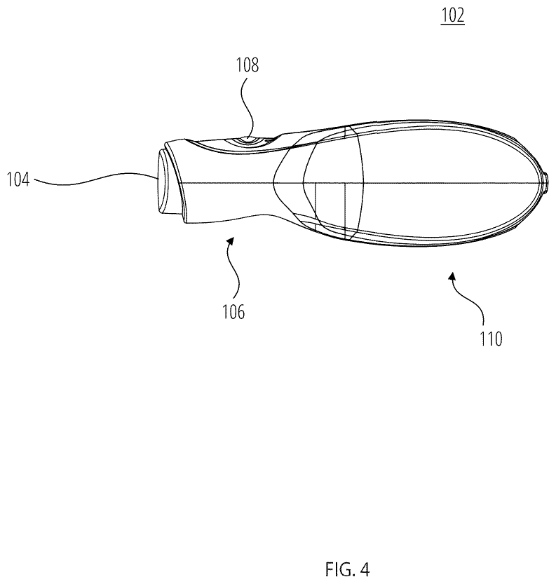

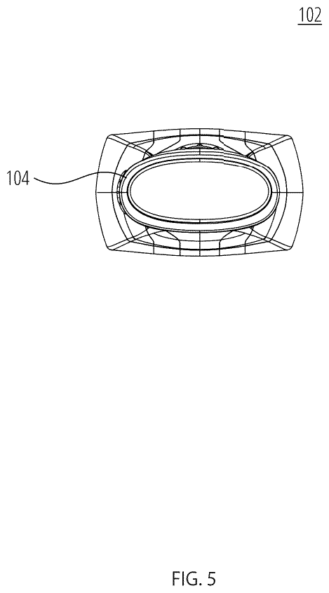

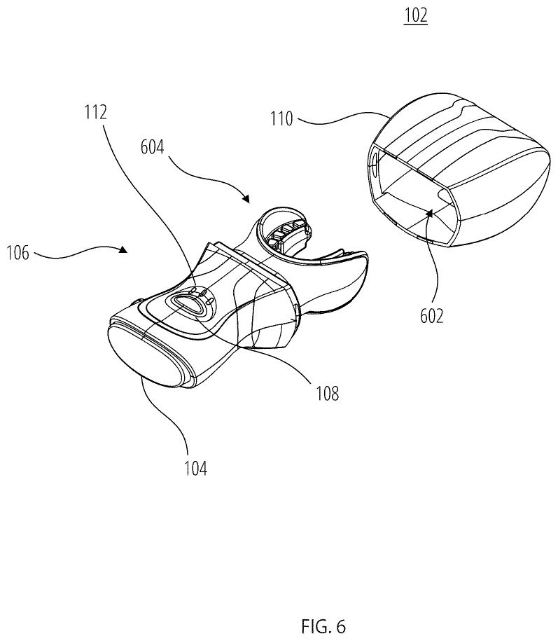

Referring now to FIGS. 1-7, there is a mouth held lighting apparatus 102 in accordance with an embodiment of the present invention. Generally, the mouth held lighting apparatus 102 comprises a lens 104, lighted housing 106, depressible button 108, covering 110, one or more status indicators 112, attachment mechanism 202, charging port 302, mouthpiece 604, first bite pad 702, and a second bite pad 704.

The mouth held lighting apparatus 102 generally comprises two main sections: a lighted housing 106 and a mouthpiece 604 with an associated covering 110. The lighted housing 106 generally contains the circuitry, programmable logic, power source, lights, and other operable components of the mouth held lighting apparatus 102. The mouthpiece 604, on the other hand, permits for support and use of the mouth held lighting apparatus 102 in the mouth of a user during operation of the mouth held lighting apparatus 102.

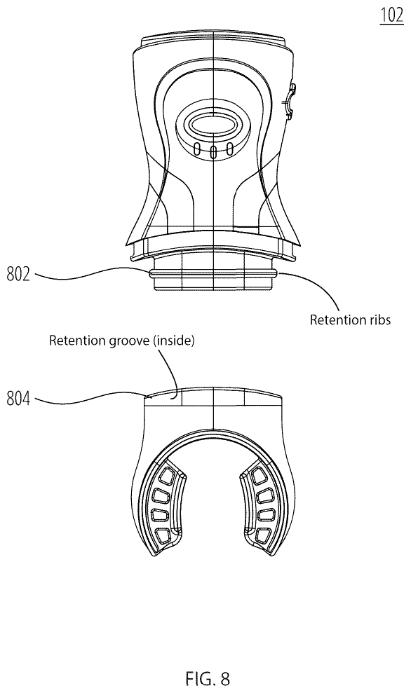

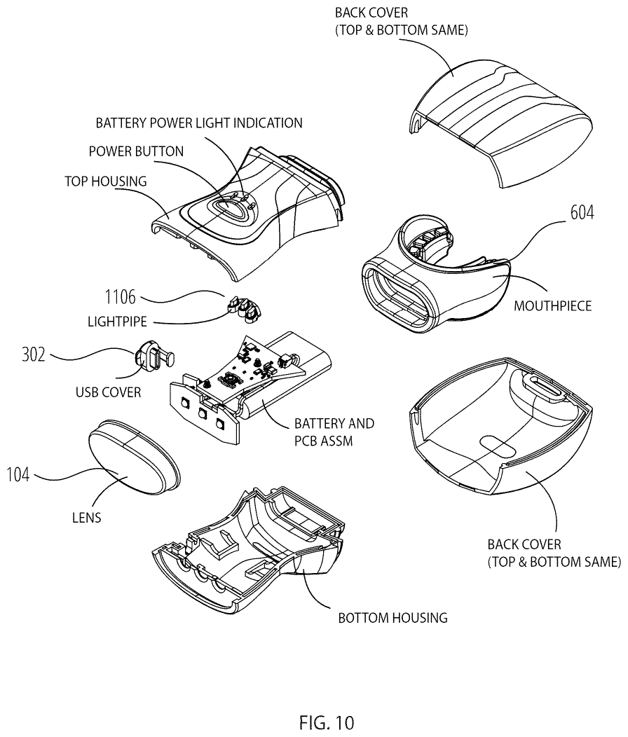

The light lighted housing 106 of the mouth held lighting apparatus 102 is preferably formed from a first section and a second section forming an interior hollow or void to allow for the housing of various components therein (see FIG. 10). As shown in FIG. 10, a first section of housing may be joinable to the second section of housing via conventional means. The charging port 302, light pipe 1106, lens 104, power source 1104, printed circuit boards 1108, one or more lighting elements 1102, depressible button 108, and one or more status indicators 112 are all housed in or coupled to the lighted housing 106. The lighted housing 106 may further be permanently affixed to the mouthpiece 604 or may be separable from the mouthpiece 604 as shown in FIG. 8.

From an exterior of the lighted housing 106, the charging port 302, depressible button 108, one or more status indicators 112, and lens 104 are readily visible. In some embodiments, the one or more lighting elements 1102 are visible behind the lens 104.

On a first end of the lighted housing 106 is a lens 104 and at a second end of the lighted housing 106 has a protrusion. The lens 104 may be a plastic, polymer, glass, or other suitable material that is adapted to let one or more wavelengths of light pass therethrough. The lens 104 may be curved or have other features configured to magnify or otherwise manipulate the appearance of the light emanating therethrough. The lens 104 may be removeable and/or interchangeable such that different lenses to create different effects or suitable for different work environments may be used.

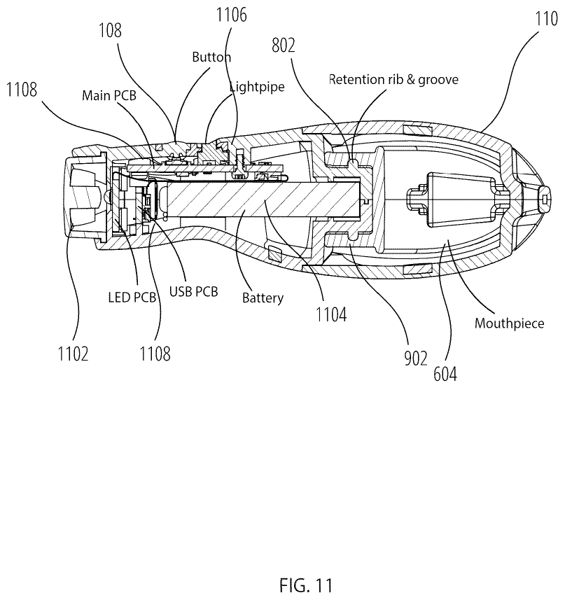

Located behind the lens 104 are one or more lighting elements 1102 as shown in FIG. 11. The one or more lighting elements 1102 are preferably one or more light emitting diodes or LEDs. The one or more lighting elements 1102 may be capable of generating multiple wavelengths of light and may be RGB LEDs. By interacting with the depressible button 108, the operative state of the LEDs may be modified as desired by the user. The one or more lighting elements 1102 are coupled to the power source 1104 such that the power source 1104 provides electrical power to cause the one or more lighting elements 1102 to illuminate.

As noted above, the one or more lighting elements 1102 may be operated by a depressible button 108. The depressible button 108 may further be communicatively coupled to the one or more status indicators 112. This allows a user to visual an operative mode (flashing, intensity, color, etc.) of the light emitted by the mouth held lighting apparatus 102. However, in other embodiments, such one or more status indicators 112 indicate the remaining charge available in the power source 1104. For example, when all three status indicators are illuminated, the power source 1104 has more than 75% of battery life remaining, when two of the three status indicators are illuminated, the power source 1104 has between 50%-75% of battery life remaining, and when only one of the three status indicators are illuminated, there is less than 50% of the battery life remaining. If no indicators are illuminated, then the battery or power source 1104 needs to be recharged. In order to direct light to the status indicators, a light pipe 1106 is used, however, other methodologies of illuminating said status indicators may be employed.

The depressible button 108 preferably allows for a simple on/off function (i.e., push to turn on the light/push to turn off light) but may include other functionality. For example, by pressing and holding the depressible button 108, the intensity of the light generated by the one or more lighting elements 1102 may be varied. Similar actions may cause a color change in the one or more lighting elements 1102 as well as turning on/off selected LEDs or causing the LEDs to flash in a particular pattern.

The charging port 302 may be a convention charging port 302 to recharge the power source 1104 of the mouth held lighting apparatus 102. Such a charging port 302 preferably takes the form of a universal serial bus or USB charging port although other charging ports are envisioned under the purview of this application. The charging port 302 is operably coupled to the power source 1104 such that connecting a charging cable to the charging port 302 preferably allows for recharging of the power source 1104 as needed and, in some embodiments, as indicated by the one or more status indicators 112.

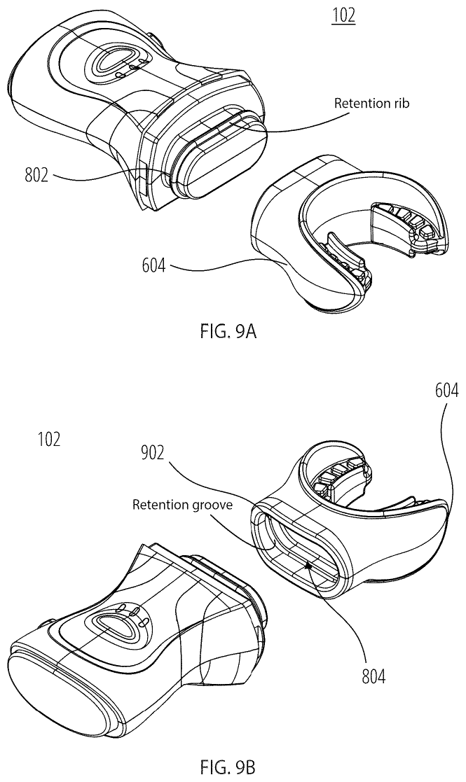

Referring now to FIGS. 8-9B, at a second end of the lighted housing 106 is a protrusion having one or more retention ribs 802. The protrusion is preferably a solid material capable of being resilient yet resisting deformation. This allows the protrusion to be paired with the recess 804 of the mouthpiece 604 to allow the two segments of the mouth held lighting apparatus 102 to be securely joined together.

The protrusion further has at least one retention rib 802 that preferably is disposed around a periphery of the protrusion. In at least one embodiment, the retention rib 802 is an O-ring which may be fixed or removable for cleaning purposes. As shown in FIG. 9B, the mouthpiece 604 has a recess 804 which has a void that is complimentary in shape to the protrusion. Thus, the protrusion should be sufficiently shaped and sized to fit snugly into the recess 804. The protrusion may fit into the recess via a friction fit, but further the recess 804 contains one or more grooves therein. The at least one groove 902 is configured to receive the retention rib 802 of the protrusion. This enables a more secure fit between the protrusion (and by extension the lighted housing 106) and the mouthpiece. In some embodiments, there are multiple retention ribs 802 and multiple grooves 902. Such an embodiment would allow for flexibility in joining the lighted housing 106 and the mouthpiece 604.

For example, the protrusion and recess 804 could be sized and shaped such that a working length of the mouth held lighting apparatus 102 could be variable based on how far the protrusion is inserted into the recess of the mouthpiece 604. Having multiple retention ribs 802 and multiple grooves 902 would allow for certain ribs/grooves to be securely engaged thereby modifying the depth to which the protrusion is in the recess 804.

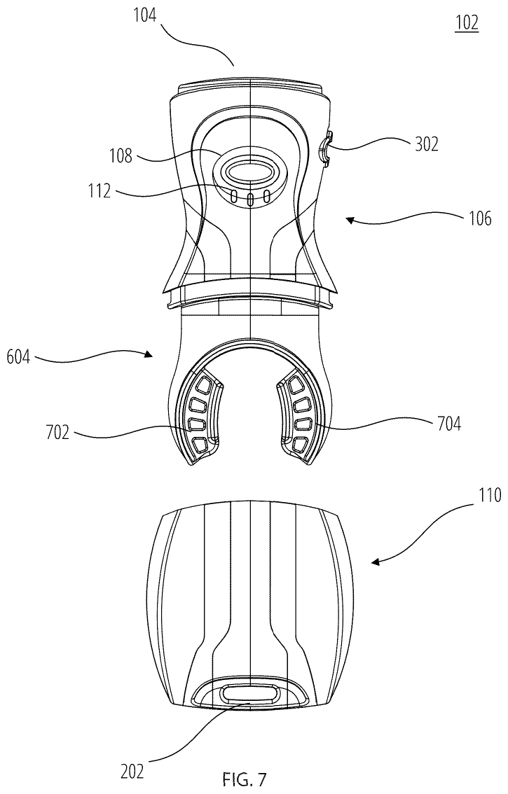

As shown in FIG. 7, the mouthpiece 604 opposite the recess 804 has a first bite pad 702 and a second bite pad 704. Each of the first bite pad 702 and the second bite pad 704 are coupled to an arcuate portion of the mouthpiece 604 such that the user can insert the mouthpiece 604 into their mouth and bite down on the first bite pad 702 and second bite pad 704 in order to secure the mouth held lighting apparatus 102 in their mouth thereby freeing up their hands to complete a task(s). Each of the first bite pad 702 and the second bite pad 704 are preferably identical but located on opposing sides of the arcuate portion of the mouthpiece 604.

In at least one embodiment, the first bite pad 702 and the second bite pad 704 are comprised of a soft and resilient material that is comfortable for a user to bite down on. There may be individual “pads” on each pad to provide a cushion for the teeth of the user. These “cushions” or “pads” may be softer than the material forming the mouthpiece 604 surrounding it. In at least one embodiment, the “pads” or “cushions” are filled with a gel. Additionally, the first bite pad 702 and the second bite pad 704 are not connected to one another. This allows for a gap between the two pads thereby allowing a user to breathe easier and make the user more comfortable as there is less overall material to be held and retained in the user's mouth. In a preferred embodiment, the mouthpiece 604 can be readily removed and cleaned and may even comprise of dishwasher safe materials to allow for easy cleaning and sanitation.

A covering 110 may also be used to help prevent debris and other contamination to the mouthpiece 604. The covering 110 is essentially a shell that fits over the mouthpiece 604 and is securely held in place when the mouth held lighting apparatus 102 is not in use. Preferably, the covering 110 is secured to the mouthpiece 604 via a friction fit, but other convention mechanisms of securement may be utilized. In one embodiment, the covering may have UV lights or other structures on the inside which can help to sterilize the mouthpiece 604 in between uses. For convenience to the user, an attachment mechanism 202 may be disposed on the covering 110 such that a lanyard or other suitable structure can be affixed thereto to allow for easy storage and/or transport of the mouth held lighting apparatus 102.

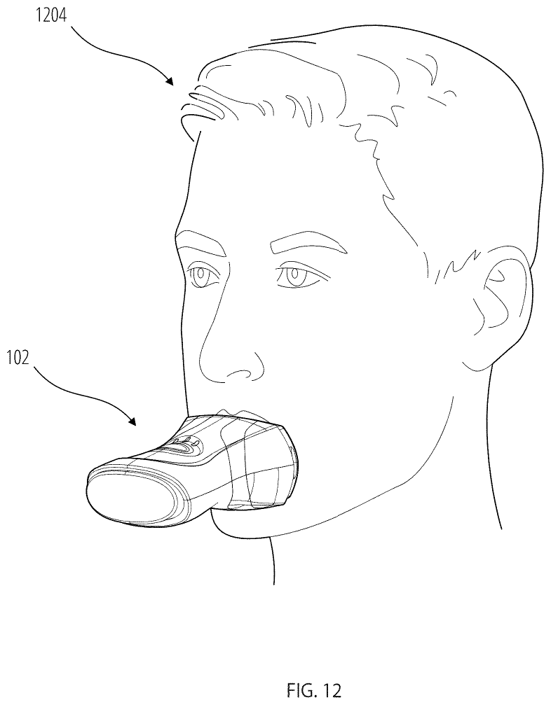

As shown in FIG. 12, there is a user 1204 with the mouth held lighting apparatus 102 being held by the user's mouth. The mouthpiece 604 is inserted into the mouth and when the user 1204 bites down on the mouthpiece 604 the mouth held lighting apparatus 102 is then securely retained therein. The user's hands are then free to manipulate operation of the mouth held lighting apparatus 102 as well as work in the user's environment to manipulate tools, open/close doors, and the like or some combination thereof.

It should be understood that the foregoing description is only illustrative of the invention. Various alternatives and modifications can be devised by those skilled in the art without departing from the spirit of the invention. Accordingly, the present invention is intended to embrace all such alternatives, modifications and variances which fall within the scope of the appended claims.

What is claimed is:

1. A mouth held lighting apparatus comprising:
a lighted housing having a first end and a second end,
wherein the second end of the lighted housing has a protrusion;
at least one lighting element coupled to the first end of the lighted housing;
a depressible button configured to change an operable state of the at least one lighting element;
a mouth piece having a first end and a second end,
wherein the first end of the mouthpiece has a recess and a second end of the mouthpiece is configured to be inserted into a mouth of a user.

2. The mouth held lighting apparatus of claim 1 further comprising a lens configured to cover the one or more lighting elements.

3. The mouth held lighting apparatus of claim 1 further comprising a cover.

4. The mouth held lighting apparatus of claim 3 wherein the cover is configured to cover the mouthpiece.

5. The mouth held lighting apparatus of claim 1 further comprising one or more status indicators.

6. The mouth held lighting apparatus of claim 1 further comprising a charging port.

7. The mouth held lighting apparatus of claim 1 wherein the second end of the mouthpiece is arcuate in shape and has a first bite pad and a second bite pad.

8. The mouth held lighting apparatus of claim 1 wherein the mouthpiece is coupled to the housing via a retention rib.

9. A mouth held lighting apparatus comprising:
a lighted housing having a first end and a second end,
wherein the second end of the lighted housing has a protrusion and at least one retainment mechanism coupled to the protrusion;
at least one lighting element coupled to the first end of the lighted housing;
a depressible button configured to change an operable state of the at least one lighting element;
a mouth piece having a first end and a second end,
wherein the first end of the mouthpiece has a recess and a second end of the mouthpiece has a first bite pad and a second bite pad,
wherein the recess has at least one groove configured to receive the at least one retainment mechanism coupled to the protrusion of the lighted housing.

10. The mouth held lighting apparatus of claim 9 wherein the first bite pad is not affixed to the second bite pad.

11. The mouth held lighting apparatus of claim 9 further comprising a universal serial bus charging port disposed in the lighted housing.

12. The mouth held lighting apparatus of claim 9 further comprising a covering configured to selectively cover the mouthpiece.

13. The mouth held lighting apparatus of claim 12 wherein the covering is configured to couple to the lighted housing via one or more securement mechanisms.

14. The mouth held lighting apparatus of claim 12 wherein an interior volume formed by the covering is larger than the mouthpiece.

15. The mouth held lighting apparatus of claim 9 further comprising a light pipe configured to direct light to one or more status indicators.

16. A mouth held lighting apparatus comprising:
a lighted housing having a first end and a second end,
wherein the second end of the lighted housing has a protrusion and at least one retainment mechanism coupled to the protrusion;
at least one lighting element coupled to the first end of the lighted housing;
a lens configured to cover the at least one lighting element;
a power source configured to supply electrical power to the at least one lighting element;
a charging port operably coupled to the power source;
a depressible button configured to change an operable state of the at least one lighting element;
a mouth piece having a first end and a second end,
wherein the first end of the mouthpiece has a recess and a second end of the mouthpiece has a first bite pad and a second bite pad,
wherein the recess has at least one groove configured to receive the at least one retainment mechanism coupled to the protrusion of the lighted housing; and
a covering having a first section and a second section with the first section and the second section defining an interior volume.
